(19) United States
(12) Patent Application Publication
(10) Pub. No.: US 2005/0164023 A1
(43) Pub. Date: Jul. 28, 2005

(54) Structurally reinforced resinous article and method of making

(76) Inventors: Scott Michael Davis, Lee, MA (US); Thomas Paul Dunton, Lebanon Springs, NY (US); Randall Todd Myers, Pittsfield, MA (US)

Correspondence Address: CANTOR COLBURN, LLP, 55 GRIFFIN ROAD SOUTH, BLOOMFIELD, CT, 06002, US

(21) Appl. No.: 10/811,441

(22) Filed: Mar. 26, 2004

Related U.S. Application Data
(60) Provisional application No. 60/539,188, filed on Jan. 26, 2004.

(51) Int. Cl. B29C 51/14

(52) U.S. Cl. 428/480; 264/510; 264/544; 156/322

(57) ABSTRACT

A process for forming a shaped, multilayer article comprises heating a reinforced resinous substrate to a thermoforming temperature to form a heated substrate; contacting a surface of the heated substrate with a surface of shaped surface component, wherein the heated substrate has a sufficient concentration of heated resin at the surface thereof for bonding the heated substrate to the shaped surface component; and thermoforming the heated substrate at a pressure less than or equal to about 500 psi (3447 kPa) to provide a bond at an interface between the surface of the thermoformed substrate and the surface of the shaped surface component.

### CROSS-REFERENCE TO RELATED APPLICATION

This application claims the benefit of U.S. Provisional Application Ser. No. 60/539,188, filed Jan. 26, 2004, which is incorporated herein by reference in its entirety.

### BACKGROUND

Structural parts for applications with aesthetic requirements are usually painted metals or composites comprising a reinforced thermosetting resin substrate with an aesthetic surface layer. Reinforced resinous composites are favored over metals in part because of their lower material costs, and greater ease of processing. However, use of thermosetting resins can produce volatile organic compound (VOC) emissions.

One approach for producing reinforced resinous aesthetic composites involves a two step procedure, wherein an aesthetic thermoplastic surface layer is formed by a traditional thermoforming method, and a reinforced thermosetting resin is disposed behind the surface layer and then cured in-place to create a bi-layered structure having a reinforced sub-layer and an aesthetic surface layer. Many different thermosetting composite systems and methods can be employed to create the reinforced sub-layer, for example, spray-up fiberglass reinforced plastic (FRP), resin transfer molding, vacuum-infusion, and various reinforced foam in-place technologies.

Despite their suitability for their intended purposes, there nonetheless remains a need in the art for new reinforced resinous aesthetic composites and methods for the manufacture of such composites. With the increasing restrictions on VOC emissions, it would be particularly advantageous if such composites and methods could result in lower VOC emissions. It would further be advantageous if such composites have good stability and excellent coefficients of thermal expansion.

### SUMMARY

In one embodiment, a process for forming a shaped, multilayer article comprises heating a reinforced resinous substrate to a thermoforming temperature to form a heated substrate; contacting a surface of the heated substrate with a surface of shaped surface component, wherein the heated substrate has a sufficient concentration of heated resin at the surface thereof for bonding the heated substrate to the shaped surface component; and thermoforming the heated substrate at a pressure less than or equal to about 500 psi (3447 kPa) to provide a bond at an interface between the surface of the thermoformed substrate and the surface of the shaped surface component.

Another embodiment comprises articles made by the above process.

### BRIEF DESCRIPTION OF THE DRAWINGS

Referring now to the Figures, which are exemplary embodiments, and wherein the like elements are numbered alike:

FIG. 1 is a schematic illustration of an exemplary reinforced resinous aesthetic composite;

FIG. 2 is a schematic illustration of a matched tool thermoforming method;

FIG. 3 is a schematic illustration of a membrane assisted vacuum/pressure thermoforming method; and

FIG. 4 is a Wavescan plot showing surface characteristics of articles in accordance with the present invention.

### DETAILED DESCRIPTION

Disclosed herein is a shaped multilayer article comprising a thermoformable surface component and a reinforced resinous substrate, wherein the substrate is joined to the surface component by thermoforming at low pressure to provide the shaped multilayer article. In contrast to the methods of the prior art, for example foam in-place technologies where the resinous substrate is formed by injecting and foaming the substrate material against the aesthetic layer, the present method uses thermoforming to join the aesthetic layer and the substrate. The method is low VOC, and efficiently provides multilayer articles having excellent physical properties.

The term “thermoforming” and its various derivatives have their ordinary meaning as used herein, and generically describe a method of heating and forming a thermoplastic material into a desired shape. Thermoforming methods and tools are described in detail in DuBois and Pribble's “Plastics Mold Engineering Handbook”, Fifth Edition, 1995, pages 468 to 498. Thermoforming methods as set forth in U.S. Pat. No. 5,601,679 to Mulcahy et al. may also be used. The term “layer” is used herein for convenience, and includes materials having an irregular shape as well as sheets and films. Further as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges disclosed herein are inclusive of the endpoints and independently combinable.

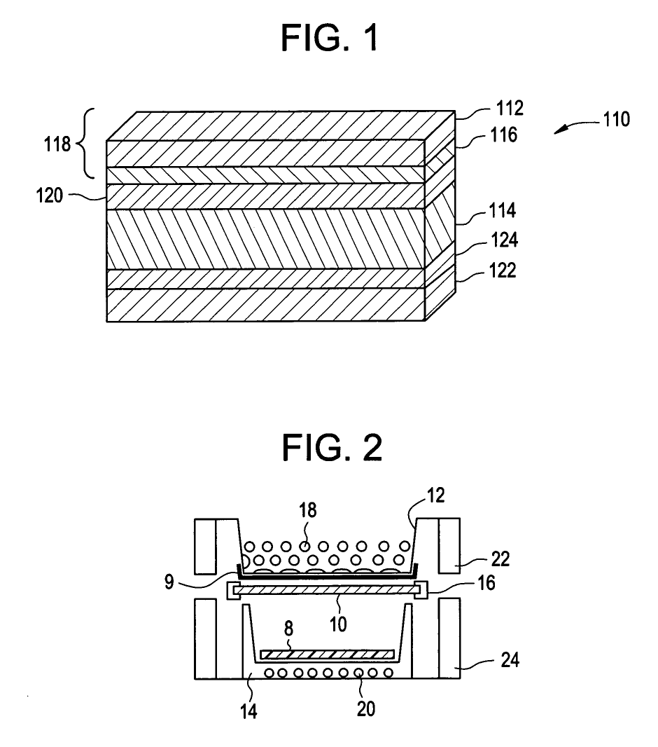

An exemplary shaped multilayer article 110 obtainable by the present method is shown in FIG. 1, and comprises a film layer 112 and a reinforced resinous substrate 114. Film layer 112 can function as a surface layer for substrate 114, and is selected to be both thermoformable and compatible with substrate 114. In one embodiment, the outer surface of the film layer may be configured with surface designs, and/or may contain additives that can provide optical effects. The resinous composite substrate comprises a fiber-reinforced resin, and may impart a desirable stiffness to the final article.

As is further shown in FIG. 1 an optional first compatible layer 116, which may comprise additives that can provide optical effects, may be disposed between film layer 112 and substrate 114. Where optional first compatible layer is used to provide an optical effect, film layer 112 may be clear and/or colorless. The combination of film layer 112 and first compatible layer 116 is often referred to as an aesthetic layer, and is shown in FIG. 1 at 118. For convenience in broadly describing and claiming the invention, the term “surface component” may be used herein to refer to film layer 112 and aesthetic layer 118. It is to be understood that additional layers may also be associated with film layer 112 and/or aesthetic layer 118, depending on the particular end use of the article and other considerations.

A first tie layer 120 may further be disposed between substrate 114 and optional first compatible layer 116 (or film layer 112, where the optional first compatible layer is not used). Tie layer 120 may be used to increase bonding between the layers. Where no tie layer is present, optional first compatible layer 116 may function to increase bonding between film layer 112 and substrate 114.

An optional balance layer 122 may be disposed on a side of reinforced resinous substrate 114 opposite film layer 112. The purpose of balance layer 122 is to provide a layer on a side of substrate 114 opposite film layer 112 that matches the coefficient of thermal expansion of film layer 112. A second optional tie layer 124 may be disposed between substrate 114 and balance layer 122. In addition, a second compatible layer (not shown) may be disposed between balance layer 122 and tie layer 124 or substrate 114. It is to be understood that article 110 may be provided in any desired shape, which will be dictated by the end use of the article.

In accordance with the present method, a reinforced resinous substrate is thermoformed and joined to a surface component in one operation at a low pressure, i.e., at a pressure of less than about b 500 pounds per square inch (psi) (3447 kilopascal (kPa)), specifically about 1 (6.9 kPa) to about 500 psi (3447 kPa), and more specifically about 1 (6.9 kPa) to about 250 psi (1235 kPa), and even more specifically about 10 (69 kPa) to about 100 psi (690 kPa). It is believed that the bond achieved by thermoforming is formed by the molecules of the adjacent layers becoming physically co-mingled, providing interpenetration between the layer. The interface thus formed is strong and well integrated with both layers. The reinforced resinous substrate thus desirably includes a sufficient concentration of resin in the surface area used for binding. Supplemental and additional thermoplastic resin may be added to the surface area in the form of a sheet of additional thermoplastic resin, for example in the form of a tie layer. The additional resin when heated increases the concentration of resin in the interface area and promotes good bonding. Of course, adhesives may optionally be used between any two layers to provide further additional bonding.

More particularly, in one embodiment, the surface component and the reinforced resinous substrate are first produced as separate layers. The surface component is provided in a shape substantially corresponding to the shape of the final multilayer article. Shaping may be by means known in the art, including molding and thermoforming. For example, a film or sheet of the thermoformable material(s) used to form the surface component may be placed over a concave mold form. Molds are typically made from a metal having high thermal conductivity, such as aluminum. Clamp frames may be activated for mechanically holding the sheet(s) in place. A suitable heat shield, such as aluminum foil, may be utilized to avoid heating the surface at selected locations such as at a location other than a sink portion. The thermoformable sheet(s) in the mold is then heated, for example by an infrared heater in thermoforming ovens. Top and bottom heaters may be used. Vacuum may be applied to draw the sheet(s) into place against the mold form, and/or a positive air pressure may be used to push the sheet(s) into the mold form. To obtain a good surface finish, openings for drawing the vacuum are preferably spaced away from an area of the part requiring an optimized surface finish. The vacuum openings may be located around the periphery of the mold form so that any aesthetic areas of the thermoformable sheet(s) are in contact with a smooth surface of the mold form.

Once the desired shape has been obtained, the thermoformed surface component is cooled below its thermoplastic temperature, typically by cooling through the mold. In one embodiment, the mold may be maintained at about 100° F. (37.8° C.) to about 270° F. (132° C.). The thermoformed surface component may optionally then be removed from the mold body or mold form. Removal may help to decrease or eliminate residual stresses. Areas of the thermoformed surface component adjacent to vacuum openings that may have some surface flaws or imperfections may be trimmed to obtain a final thermoformed surface component free of surface imperfections, for example by laser trimming, water jet trimming, trim press trimming, and the like. The thermoformed surface component may then be replaced in the mold, or placed in or on a new mold form. In an embodiment, the surface component is thermoformed and remains on the tool.

A sheet of resinous composite substrate material may then be placed adjacent to a side of the surface component opposite the mold form. Before or after placement, preferably before placement, the sheet of resinous composite substrate material is heated to a temperature and for a time sufficient to reach a “softening” or “working” temperature, that is, a temperature that will allow the sheet to be simultaneously thermoformed and adhered to the thermoformed surface component at low pressures, i.e., about 500 psi (3.45 MPa) or less. Typical processing temperatures for the substrate materials described below are about 500 to about 700° F. (about 260 to about 371° C.). Particular pressures and times will depend on the materials chosen for the substrate material and surface component, the temperature to which the substrate material is heated, the temperature to which the thermoformed surface component is cooled, and the desired cycle time, and are readily determined by one of ordinary skill in the art without undue experimentation.

In one advantageous feature of the present method, the cooled mold form holding the surface component aids in maintaining the temperature of the thermoformed surface component below the softening or working temperature of the resinous composite substrate material during thermoforming and joining. A surface component may thus be initially thermoformed on a convex tool, for example, such that the aesthetic surface is not in contact with the tool. The surface component may then be cooled, optionally masked, placed in a cooled (e.g., room temperature) concave tool, and the substrate thermoformed behind it. The aesthetic surface, because it is adjacent the cooled, concave molding tool, does not reach as high a temperature as the heated substrate, which aids in preserving the aesthetic surface of the thermoformed surface component.

As shown in FIG. 2, a matched tool process may be used to urge the heated resinous composite substrate material against the thermoformed surface component. In this process, optional balancing layer 8 may be placed in female tool 14. Thermoformed surface component 9 is placed against male forming tool 12, and heated substrate material 10 is held in position relative to a male forming tool 12 and female forming tool 14 using clamps 16. The male forming tool 12 and the female forming tool 14 are configured to “match”, i.e., complement each other. This process may also be carried out with the relative positions of the female and male tools being switched. The male forming tool 12 and the female forming tool 14 may further comprise a plurality of holes 18 and 20, respectively, for drawing a vacuum and/or temperature regulation. Disposed at a periphery of male forming tool 12 and female forming tool 14 are stops (spacers) 22 and 24 respectively, which are used to determine the thickness of the shaped substrate. The stops 22 and 24 are positioned outside of the forming area.

The male forming tool 12 and female forming tool 14 are brought in physical contact with each other via stops 22, 24 under a low pressure, and for a time sufficient to thermoform heated substrate material 10 to the desired shape and adhere the substrate material to thermoformed surface component 9. A difference in air pressure may be used to urge heated substrate 10 into contact with thermoformed surface component 9. For example, where heated substrate 10 retains a degree of porosity, a pressure gradient such as a vacuum may be established through substrate 10 between male forming tool 12 and the surface of surface component 9 and the mold cavity, which are non-porous.

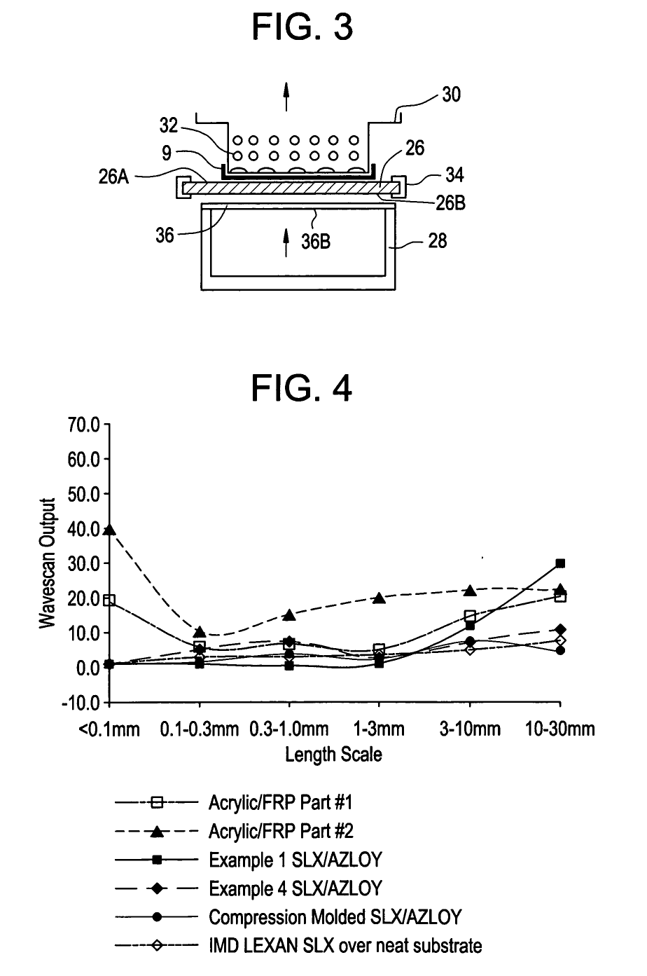

In another embodiment, as shown in FIG. 3, a conformable pressure transmitting medium may be used to urge a heated resinous composite substrate material against a thermoformed surface component. In this process, thermoformed surface component 9 is placed against a male forming tool 30, and a heated resinous composite material 26 is disposed between a pressure box 28 and a forming tool 30. While forming tool 30 is illustrated as a male forming tool, it may alternatively be a female forming tool. Clamps 34 may be used to hold the substrate sheet in position relative to pressure box 28 and forming tool 30. A membrane 36, more specifically, a non-permeable membrane, is stretched across the opening of the pressure box 28. A pressure is applied to membrane 26 from the side 26B opposite the side adjacent heated substrate material 26. A vacuum may also be used to pull heated substrate material 26 into contact with thermoformed surface component 9.

A tie layer may be disposed between the surface component and the substrate. Incorporation of a tie layer is conveniently accomplished by inserting it at the interface between the surface component and the substrate immediately before thermoforming and joining. Use of a tie layer can provide enhanced bonding between the surface component and the substrate by increasing the amount of resin at the interface, and/or by improving the compatibility between the surface component and the substrate, particularly where the surface component and the substrate comprise different resins. The viscosity of the tie layer resin may be greater than, comparable to, or less than the viscosity of the resin of the reinforced resinous substrate. In one embodiment, the viscosity of the tie layer resin is greater than the resin of the reinforced resinous substrate.

In still another embodiment, an optional balance layer may be disposed on a side of the reinforced resinous substrate opposite the surface component. In practice, the optional balance layer may be associated with the reinforced resinous substrate before or after it is thermoformed and joined to the thermoformed surface component. A second compatible resin layer may be disposed between the substrate and the balance layer, or a tie layer may be at the interface between the substrate and the balance layer. Alternatively, where a second compatible layer is disposed between the substrate and the balance layer, a tie layer may be further disposed at the interface between the substrate and the second compatible resin layer. Additional layers, for example adhesive layers, may also be used where desirable.

In the above-described processes, the surface component may be a film layer or an aesthetic layer. Additional layers may also be present in the surface component, for example an adhesive layer. When an aesthetic layer is used, the first compatible layer thereof may be placed in contact with the reinforced resinous substrate, such that the interpenetrating bond is formed at an interface between a surface of the substrate and a surface of the first compatible layer opposite the film layer. A tie layer may then be present at the interface between the substrate and the first compatible layer.

In one specific embodiment, an aesthetic layer may be thermoformed with the first compatible layer adjacent the surface of the mold, for example a concave mold. The aesthetic layer is then cooled, removed from the concave mold, and placed on a convex mold having a shape that corresponds to the concave mold, such that the film layer is in contact with the convex mold. A heated substrate material is then placed in position between the compatible first resin layer and a tool matching the convex mold or the diaphragm of a pressure box as described above, followed by joining and thermoforming the substrate to the first compatible layer. A tie layer may be placed at the interface between the substrate and the first compatible layer. Use of this process can yield articles with film layers having very smooth surfaces, because the surface of the film layer is not contacted with a heated mold form. A film layer alone may be used in place of the aesthetic layer, with or without a tie layer.

After thermoforming the substrate to produce the multilayer article, it may be trimmed to substantially the final shape of the desired article, for example by laser trimming, water jet trimming, trim press trimming, and the like.

The details of the above described thermoforming methods are provided merely for exemplary purposes. It is to be understood that a wide variety of thermoforming methods may be used for the shaping of the thermoformed film and/or the substrate layer.

Materials suitable for use as a film layer, resinous composite substrate, optional first compatible resin layer, optional second compatible resin layer, optional tie layers and optional balance layer are thermoformable and may comprise a thermoplastic polymer or a miscible, immiscible, or compatibilized blend of thermoplastic and/or thermosetting polymers. Suitable polymers, blends, alloys, and copolymers include, for example, polycarbonates (PC), polyesters such as poly(ethylene terephthalate) (PET), poly(1,4-butylene terephthalate) (PBT), poly(trimethylene terephthalate) (PTT), poly(ethylene naphthalate) (PEN), poly(butylene naphthalate) (PBN), poly(cyclohexanedimethanol terephthalate), poly(cyclohexanedimethanol-co-ethylene terephthalate) (PETA), and poly(1,4-cyclohexanedimethyl-1,4-cyclohexanedicarboxylate) (PCCD), polyamides, polyetherimides, polyphenylene ethers, PC/ABS (wherein ABS is an acrylonitrile-butadiene-styrene resin), PC/ASA (wherein ASA is an acrylic-styrene-acrylonitrile resin), PC/PBT, PC/PET, PC/polyetherimide, polyester/polyetherimide, polyphenylene ether/polystyrene, polyphenylene ether/polyamide, polyphenylene ether/polyester, and the like, as well as combinations comprising at least one of the foregoing polymers, blends, alloys, or copolymers.

As noted above, the resin used in the thermoformable film and in the balancing layer are the same or similar. In one embodiment, the thermoformable film resin may be clear, and may impart desirable properties of weatherability and/or UV resistance to the article. A specific resin having these properties is an arylate polyester resin. As used herein, an “arylate polyester resin” is a resin comprising one or more arylate polyester units derived from a diphenol residue and an aromatic dicarboxylic acid residue. In one embodiment the diphenol residue is derived from a substituted or unsubstituted 1,3-dihydroxybenzene of Formula 1: 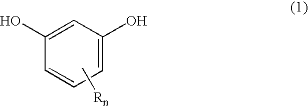
wherein R may be a C₁₋₁₂ alkyl unit or halide, and n is 0 to 3. 1,3-dihydroxybenzene is also commonly known as resorcinol.

Examples of suitable dicarboxylic acid residues include aromatic dicarboxylic acid residues derived from monocyclic aromatic dicarboxylic acids, polycyclic aromatic dicarboxylic acids, and the like. Exemplary suitable monocyclic aromatic dicarboxylic acids include isophthalic acid, terephthalic acid, and the like, and mixtures thereof. Exemplary suitable polycyclic dicarboxylic acids include diphenyl dicarboxylic acid, diphenylether dicarboxylic acid, naphthalene dicarboxylic acids such as naphthalene-2,6-dicarboxylic acid, and the like. Combinations comprising one or more of the foregoing dicarboxylic acids may also be used. Non-aromatic dicarboxylic acids such as 1,4-cyclohexanedicarboxylic acid may be used in combination with the aromatic dicarboxylic acids.

In one embodiment, the aromatic dicarboxylic acid residues are derived from mixtures of isophthalic and terephthalic acids residues (ITR) as illustrated in Formula 2. 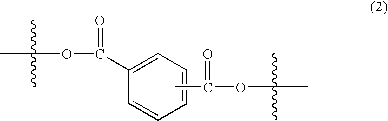
Thus, a specific arylate polyester unit is a resorcinol polyester unit of Formula 3: 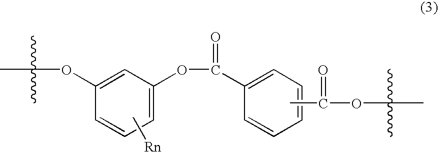
wherein R and n are as defined above.

In another embodiment, the arylate polyester resin is a block copolyester carbonate comprising arylate polyester-containing block segments in combination with organic carbonate block segments as shown in Formula 4: 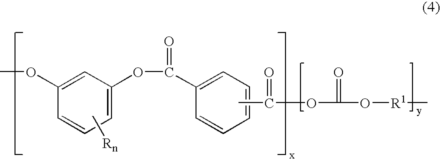
wherein R and n are as described above, x is at least 1 and y is at least 1, and R₁ is a divalent organic radical, wherein at least 60 mole % of the divalent organic radicals are derived from an aromatic dihydroxy compound, for example 2,2-bis(4-hydroxyphenyl)propane (“Bisphenol A”), bis(2-hydroxyphenyl)methane, 1,1-bis(4-hydroxyphenyl)-3,3,5-trimethylcyclohexane, fluorenone bisphenol, 1,1-bis(4-hydroxyphenyl)ethane, 2,6-dihydroxynaphthalene, bis(3,5-diethyl-4-hydroxyphenyl)sulfone, 2,2-bis(3,5-dibromo-4-hydroxyphenyl)propane, 4,4′-dihydroxydiphenyl ether, spiro biindane bis phenol, and the like.

In one embodiment, the molar ratio of x:y is about 10-90:90-10. Where high levels of scratch and/or chemical resistance are desired, the arylate polyester-containing blocks may comprise about 50 mole percent to about 100 mole percent of the film layer, with the remainder being polycarbonate units. In one specific embodiment, the arylate polyester-containing blocks are derived from resorcinol (wherein n=0), a mixture of isophthalic and terephthalic acids residues wherein the molar ratio of isophthalic acid to terephthalic acid residues is about 0.25-4.0:1, and polycarbonate blocks wherein R¹ is derived from bisphenol A.

Methods for the manufacture of such block copolyester carbonates are known, being disclosed, for example, in Patent Application EP 01124878.

The first and second compatible resin layers and the tie layers comprise a material that is selected to be compatible with the film layer and the resinous composite substrate. As used herein, “compatible” means that the layers are capable of being joined by thermoforming, and do not adversely interact with each other. Specific examples of compatible materials for use in the tie layer include polycarbonates; polyesters such as isoterephthalate resorcinol, PET, PBT, PTT, PEN, PBN, PETA and PCCD; polyetherimides; polyamides; polyalkylene arenedioates; polyacrylonitrile-containing resins such as, for example, ABS, ASA, or acrylonitrile-(ethylene-polypropylene diamine modified)-styrene (AES); phenylene sulfide; polymethyl methacrylate (PMMA); copolyester carbonates; poly(alkylene dicarboxylates); or the like; or combinations comprising at least one of the foregoing polymers. In one embodiment, the tie layer comprises a blend of a resin from the film layer and a resin from the substrate layer.

Polycarbonates and blends of polycarbonates with polyesters may be advantageously be used in the compatible layers and tie layers, particularly in combination with film layers comprising the arylate polyester resins as described above. As is known, polycarbonates possess recurring structural units as shown in Formula 5: 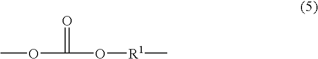
wherein R¹ is as defined above. Suitable polycarbonate resins include linear aromatic polycarbonate resins, for example those comprising units derived from bisphenol A, and branched aromatic polycarbonate resins. In one embodiment, the compatible resin layer comprises a transparent blend of PCCD and polycarbonate. Applicants have found that use of this blend affords a layer with ductility and increased adhesion between the film layer and a tie layer or substrate comprising polycarbonate. The blends of PCCD/PC have excellent clarity, physical and mechanical properties. In one embodiment, the blend comprises about 20 to 100 wt. % PCCD and about 80 to 0 wt. % of the polycarbonate.

In another embodiment, polyesters and blends comprising two or more polyesters may be advantageously be used in the compatible layers and/or tie layers, particularly in combination with film layers comprising the arylate polyester resins as described above. For example, one suitable blend for use in the tie layer comprises, based on the weight of the blend, about 10 to about 50 weight percent (wt. %) of PBT, PET, glycolized poly(ethylene terephthalate) (PETg), poly(cyanoterephthalydene) (PCT) and about 50 to about 90 wt. % of an arylate polyester resin, specifically a resorcinol polyester resin as described above, and about 50 percent to about 90 percent of a resin comprising resorcinol arylate units.

The thermoformable film layer, compatible layers, and/or tie layers may be produced separately by methods such as molding, extrusion, coating, casting, vacuum deposition, or the like. The layers may then be adhered using an adhesive and/or laminated. In applications wherein the aesthetic layer and/or balance layer is in the form of a film, the compatible resin layers and/or the tie layer may serve as a reinforcement to facilitate the handling of the film, which may have relatively little inherent tensile strength.

Alternatively, the thermoformable film layer and the first compatible layer may be produced in the form of a laminate by co-injection molding, co-extrusion, overmolding, coating, or the like. For example, the film layer and first compatible layer (and other optional layers) may be extruded from separate extruders through separate sheet dies into contact with one another when hot, and then passed through a single sheet of rollers. In another embodiment, the polymer melts of the materials constituting the film layer, compatible resin layer and/or tie-layer and other optional layers may be brought together and into contact with one another through a co-extrusion adapter/feed block and then through a single or multi-manifold die. The adapter/feed block is constructed such that the melts forming the separate layers are deposited as adherent layers on the melt of the center layer. After co-extrusion, the multilayer length of the melt produced can be formed into desired shapes; solid sheets or multi-wall panels, in an extrusion die connected downstream. The melt is then cooled under controlled conditions in known manner by means of calendaring (solid sheet) or vacuum sizing (multi-wall panel) and subsequently cut into lengths. An annealing oven may be optionally provided after sizing or calendaring for the reduction of stresses.

In one embodiment, the thickness of the film layer or aesthetic layer is chosen to be sufficient to cover minor surface blemishes in the substrate, resulting in a durable, high grade, Class “A” finish. Such finishes are of particular utilitity in automotive applications. In another embodiment, the film layer may have a thickness of about 5 mils (0.13 millimeters) to about 20 mils (0.51 millimeters). The tie layer may have a thickness of about 10 mils (0.25 millimeters) to about 55 mils (1.4 millimeters). In another embodiment, the aesthetic layer may have a thickness of about 15 mils (0.38 millimeters) to about 125 mils (3.18 millimeters), more specifically about 30 mils (0.76 millimeters) to about 90 mils (2.3 millimeters).

The reinforced substrate resin layer comprises a resin or resin blend, alloy, or copolymer that is thermoformable and that is compatible with the film layer and/or tie layer. Examples of specific suitable thermoplastic resins include polycarbonates and polyester resins such as resorcinol isoterephthalate, PET, PBT, PTT, PEN, PBN, PETA, PCCD, polyesters available from renewable agricultural or other resources such as vegetable or animal material, biomass (i.e., formed of polylactic acid), and the like, as well as combinations comprising at least one of the foregoing thermoplastic polyester resins. Blends of polyesters with polycarbonates may also be used.

In addition to a thermoformable resin or resin blend, the substrate comprises a reinforcing component, for example a fibrous reinforcing material. The reinforcing component is selected in part so as to impart the desired stiffness to the substrate. Suitable fibrous materials may comprise glass, for example E-glass, S-glass, basalt, or the like, carbon, ceramics, polyethylene terephthalate, polyamide, and the like, or combinations comprising at least one of the foregoing fibrous materials. The fibers may be about 0.25 inches (6.35 millimeters) to about 1.5 inches (38.1 millimeters) in length, more preferably about 0.50 inches (12.7 millimeters) to about 0.75 inches (19.05 millimeters) in length. Fibers having diameters of about 1 to about 150 micrometers, more specifically about 50 to about 100 micrometers may be used. The fibers may be woven or randomly oriented in the resin, for example in the form of a dense mat. In one embodiment, glass fibers are used. A sizing agent compatible with the resin may also be used.

The ratio of fibers to polymers, as well as the amount of the substrate used to form the final multilayer product may be varied in order to meet individual requirements of cost, performance, and stiffness, and will depend on the particular types and sizes of fibers, as well as the resinous material. In one embodiment, the substrate may comprise about 15 to about 70 wt. % glass fibers and about 30 to about 85 wt. % resin, based on the total weight of the substrate material, and more specifically about 20 to about 55 wt. % glass fibers and about 45 to about 80 wt. % resin, based on the total weight of the substrate material. In one embodiment, the substrate may have a thickness of about 50 mils (1.3 millimeters) to about 1000 mils (25.4 millimeters), more preferably about 75 mils (1.9 millimeters) to about 250 mils (6.35 millimeters).

Known techniques may be used for production of the substrate, for example, the Wiggins Teape process. In this and similar processes, the resin materials and optional additives are metered and dispersed into a mixing tank fitted with an impeller. The fibers and thermoplastic resin binder are dispersed, and the mixture is pumped to a head-box via a distribution manifold. The head box is located above a wire section of a machine of the type utilized for papermaking. The dispersed mixture passes through a moving wire screen using a vacuum, continuously producing a uniform, fibrous web impregnated with resin. The wet web is passed through a dryer to reduce moisture content and to melt the thermoplastic resin binder. A scrim layer may also be attached to one side or to both sides of the web to facilitate ease of handling the reinforced resin sheet. The sheet is then passed through tension rolls and continuously cut (guillotined) into a desired size. Substrates prepared according to this process desirably have a high strength-to-weight ratio, high impact properties, good chemical resistance, and may be economically produced. In one embodiment, the substrate has a degree of porosity that may be retained during the joining of the film or tie layer to the substrate by the thermoforming process.

Depending on the particular end use of the article, the film layer, compatible resin layers, tie layers, substrate, and/or balancing layer may include one or more additives for the provision or enhancement of a visual effect. The visual effect additive is of particular utility when it is present in the first compatible resin layer. Such additives include but are not limited to pigments, decorative materials such as metal flakes, dyes, and luminescent compounds. Specific examples of suitable visual effect additives include metal oxides such as titanium dioxide and iron oxide; metal hydroxides; metal flakes such as aluminum flake; chromates such as lead chromate; sulfides; sulfates; carbonates; carbon black; silica; talc; china clay; phthalocyanine blues and greens, organo reds; organo maroons and other organic pigments and dyes. The colorants may be used to provide opacity, for example in amount of less than or equal to about 5 wt. %, based on the total weight of the layer. For example, Solvent Yellow 163 may be used in an amount of about 0.35 wt. % to provide a yellow tie layer.

In an exemplary embodiment, pigments that are stable at high temperatures are used, i.e., colorants that do not substantially degrade or alter at temperatures at or about 350° C. Examples of suitable pigments that are stable at high temperatures include Solvent Yellow 93, Solvent Yellow 163, Solvent Yellow 114, Disperse Yellow 54, Solvent Violet 36, Solvent Violet 13, Solvent Red 195, Solvent Red 179, Solvent Red 135, Solvent Orange 60, Solvent Green 3, Solvent Blue 97, Solvent Blue 104, Solvent Blue 104, Solvent Blue 101, Macrolex Yellow E2R, Disperse Yellow 201, Disperse Red 60, Diaresin Red K, Colorplast Red LB, Pigment Yellow 183, Pigment Yellow 138, Pigment Yellow 110, Pigment Violet 29, Pigment Red 209, Pigment Red 209, Pigment Red 202, Pigment Red 178, Pigment Red 149, Pigment Red 122, Pigment Orange 68, Pigment Green 7, Pigment Green 36, Pigment Blue 60, Pigment Blue 15:4, Pigment Blue 15:3, Pigment Yellow 53, Pigment Yellow 184, Pigment Yellow 119, Pigment White 6, Pigment Red 101, Pigment Green 50, Pigment Green 17, Pigment Brown 24, Pigment Blue 29, Pigment Blue 28, Pigment Black 7, lead molybdates, lead chromates, cerium sulfides, cadmium sulfoselenide, cadmium sulfide, and the like, as well as combinations comprising at least one of the foregoing pigments.

Other additives may also be present in the film layer, tie layer, substrate, and/or balancing layer, again depending on the particular end use of the article. For example, one or more layers may comprise a light fastness compound, a light fastness antioxidant, and/or a light fastness ozonant, for example didodecyl-3,3′-thio dipropionate, tris(4-tert-butyl-3-hydroxy-2,6-dimethyl benzyl)isocyanurate, 1,3,5-trimethyl-2,4,6-tris(3,5-di-tert-butyl-4-hydroxybenzyl)benzene, N,N′-beta,beta′-naphthalene-4-phenylene diamine, 4,4′-methylene-bis(dibutyl dithio-carbamate), 2,2,4-trimethyl-1,2-hydroquinoline, and the like.

Other exemplary additives include impact modifiers, ultraviolet light absorbers absorbers, flame retardants, fillers, stabilizers, ester interchange inhibitors, adhesion promoting agents such as a bisphenol derivative, an aminosilane or derivatives thereof, and mold release agents. Examples of ultraviolet light absorbers include benzotriazole, benzophenone, triazine, cyanoacrylate, dibenzoylresorcinol, benzoxazinone, and the like, as well as hindered amine light stabilizers (HALS) such as 2-(benzotriazol-2-yl)-4-(1,1,3,3-tetramethylbutyl)phenol, 2-(benzotriazol-2-yl)-4-methylphenol, 2-hydroxy-4-octyloxy benzophenone, 2-hydroxy-4-methoxybenzophenone, ethyl-2,2-diphenyl-1-cyanoacrylate, 2-(2′-hydroxy-4′-octyloxy)bis-4,6-(2′,4′-dimethylphenyl)triazine, 2-ethyl-2′-ethoxy oxalanide, bis [2-hydroxy-5-methyl-3-(benzotriazol-2-yl)phenyl]-methane, and the like. Combinations comprising one or more of the foregoing additives may also be used. Such additives are of particular utility in the film layer.

Articles formed using the materials and methods disclosed herein may include, but are not limited to, exterior and interior components for aircraft, automobiles, truck, military vehicle (including automotive, aircraft, and water-borne vehicles), scooters, and motorcycles, including panels, quarter panels, rocker panels, vertical panels, horizontal panels, trim, pillars, center posts, fenders, doors, deck lids, trunk lids, hoods, bonnets, roofs, bumpers, fascia, grilles, mirror housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; wind turbine blades and housings; enclosures for electrical and telecommunication devices; outdoor furniture; aircraft components; boats and marine equipment, including trim, enclosures, and housings; outboard motor housings; depth finder housings, personal water-craft; jet-skis; pools; spas; bathtubs, hot-tubs; sinks, shower bases, shower surrounds, bathroom walls, steps; step coverings; building and construction applications such as glazing, roofs, windows, floors, decorative window furnishings or treatments; treated glass covers for pictures, paintings, posters, and like display items; optical lenses; ophthalmic lenses; corrective ophthalmic lenses; implantable ophthalmic lenses; wall panels, and doors; counter tops; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; phone bezels; mobile phone housings; radio sender housings; radio receiver housings; light fixtures; lighting appliances; reflectors; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications. Embodiments contemplate additional fabrication operations on said articles, such as, but not limited to, molding, in-mold decoration, baking in a paint oven, lamination, and/or thermoforming.

Articles utilizing embodiments are useful in a variety of structural applications where it is desirable to have a weatherable and/or paint-like appearance on the article, e.g., in applications having a need for: (a) an adequate life span upon exposure to heat, sun, chemicals, and/or the like; (b) scratch resistance, luster, and/or resistance to marring; (c) high gloss and retention of same; (d) depth of image and/or color uniformity; (e) resistance to gasoline, solvents and/or acid spotting; (f) satisfactory hardness and/or abrasion resistance; (g) acceptable UV resistance; (h) resistance to water and humidity exposure; (h) generally consistent coloration throughout at least one color layer, i.e., throughout the substrate or other layer; (i) metallizing material/particles approximately uniformly distributed throughout the substrate or other layer(s) of the article; and/or (j) ability to manufacture the articles using readily available industrial equipment such as vacuum forming devices, extrusion devices and/or injection molding machines.

The invention is further illustrated by the following non-limiting examples. All references cited herein are incorporated in their entirety. In these examples, the film layer comprises a block copolyester carbonate comprising arylate polyester-containing block segments in combination with organic carbonate block segments (LEXAN® SLX film, commercially available from GE Advanced Materials) and the substrate layer is a glass-reinforced laminate (AZLOY®, or AZMET® available from Azdel, Inc., Shelby N.C.). The laminates may comprise resins such as PC, polyphenylene ether/polyamide, polyetherimide (ULTEM from GE Plastics) PBT, polyphenylene ether, polyphenylene ether/polystyrene, and PC/PBT blends. The LEXAN® SLX film is extruded using a single or multi-manifold die. AZLOY® is sheeted using a needle mat, continuous mat or co-extrusion lamination process.

### EXAMPLE 1

### Matched Tool Forming of SLX and AZLOY®

LEXAN® SLX film is sheeted and thermoformed to a “skin” of the final part, taking care that the aesthetic surface does not come into contact with the tool. The thermoformed film is then placed on the female part of a matched tool. An AZLOY® sheet, with or without a LEXAN® polycarbonate film as a tie-layer, is preheated in a thermoforming oven to about 450° F. (232° C.) to about 650° F. (343° C.) and transferred to the male part of the matched tooling. The top and bottom platens come together and a pressure of about 1 (7 kPa) to less than 500 psi (3447 kPa) is applied. The shaped multilayer structure is removed from the tool and any excess is trimmed.

### EXAMPLE 2

### Pressure Assist Forming of SLX and AZLOY

LEXAN® SLX film is sheeted and thermoformed to a “skin” of the final part, taking care that the aesthetic surface does not come into contact with the tool. The thermoformed film is then placed on the female part of a matched tool having holes for air evacuation. An AZLOY® sheet, with or without a LEXAN® polycarbonate film as a tie-layer, is preheated in a thermoforming oven to about 450° F. (232° C.) to about 650° F. (343° C.) and transferred to the diaphragm of a pressure box on a platen. The top and bottom platens come together and a pressure of about 1 (7 kPa) to 500 psi (3447 kPa) is applied to the bladder. Vacuum between about 0 and about 14.7 psi (101 kPa) is pulled through the tool to ensure complete air evacuation. The multilayer structure is removed from the tool and any excess is trimmed.

### EXAMPLE 3

### Single Matched Tool Forming of SLX and AZLOY

Example 3 is similar to Example 1 except that instead of a film thermoforming tool and a set of matched tooling, only one matched set of tooling is used. LEXAN® SLX film is sheeted and thermoformed to an aesthetic component of the final article. Unlike example 1, the SLX is formed with the aesthetic side coming into contact with the tool surface. The film is left on the part such that it maintains a tight fit. Excess film is trimmed away as necessary while the film is on the tool. AZLOY® with or without a LEXAN® polycarbonate film as a tie-layer is heated in a thermoforming oven to between about 450° F. (232° C.) to about 650° F. (343° C.) and transferred to the matched tooling. The top and bottom platens come together and a pressure of about 1 (7 kPa) to less than 500 psi (3447 kPa) is applied. The final shaped multilayer structure is removed from the tool and any excess is trimmed.

### EXAMPLE 4

### Pressure Assist Forming of SLX and AZLOY

Example 4 is similar to Example 2 except that instead of a film thermoforming tool and a second tool with a pressure box, only one tool with a pressure box is used. LEXAN® SLX film is sheeted and thermoformed to a aesthetic component of the final part. Unlike example 2, the SLX is formed with the aesthetic side coming into contact with the tool surface. The film is left on the part such that it maintains a tight fit. Excess film is trimmed away as necessary while the film is on the tool. Holes are added to the tool where necessary for air evacuation. AZLOY® with or without a LEXAN® polycarbonate film as a tie-layer is heated in a thermoforming oven to between 450° F. (232° C.) to about 650° F. (343° C.) and transferred to the tooling. The top and bottom platens come together and a pressure of between about 1 (7 kPa) to 500 psi (3447 kPa) is applied to the bladder. Vacuum between about 0 and about 14.7 psi (101 kPa) is pulled through the tool to ensure complete air evacuation. The composite structure is removed from the tool and any excess is trimmed.

### EXAMPLE 5

### Three Step Process to Form SLX and AZLOY Multilayer Article

LEXAN® SLX film is sheeted and thermoformed to an aesthetic component of the final part taking care that the aesthetic surface does not come into contact with the tool. This aesthetic component is then trimmed such that it is roughly the shape of the final part. AZLOY® is also formed to the shape of the final part by heating the material in a thermoforming oven to between about 450° F. (232° C.) and about 650° F. (343° C.) using either a pressure assist technique or matched tooling process. These two parts are trimmed as necessary and an adhesive is applied between the two parts. Heat and pressure are applied as necessary to activate the adhesive and form the final part.

Characterization of surfaces may be carried out using a BYK Gardner Wavescan machine as described by E. Brister et al., in “Zero VOC SOLLX Film for Weatherable, High-gloss, Chemical and Scratch Resistant Performance,” Proceedings of the 29^{th} International Waterborne, High-Solids, & Powder Coatings, February 2002, pp. 261-275. This device produces measures the reflection of light images in 30 mm increments over a range of less than 1 mm to 30 mm, with lower values corresponding to better surfaces.

Wavescan results for various articles made using the above-described processes and comparison examples are shown in FIG. 4. As may be seen from the Figure, overall higher numbers are obtained for one commercially sold acrylic/FRP systems (curve A) than another commercially sold acrylic/FRP system (curve B). Data from another comparative example, using a LEXAN® SLX aesthetic film compression molded over a substrate (XENOY resin) under high pressure is shown in curve C. Excellent results are obtained for another comparative example comprising a polycarbonate aesthetic film (IMD LEXAN® SLX, GE Plastics) injection molded behind the thermoformed film, in accordance with the prior art (Curve D). Excellent results are also obtained for an article comprising a LEXAN® SLX aesthetic film on an AZLOY substrate made in accordance with Example 4 (curve E); and an article comprising a LEXAN® SLX aesthetic film over an AZLOY substrate made in accordance with Example 2 (curve F). It can thus be seen that the presnet method provides articles that have excellent aesthetic properties.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process for forming an article, comprising
heating a reinforced resinous substrate to a thermoforming temperature to form a heated substrate;
contacting a surface of the heated substrate with a surface of shaped surface component, wherein the heated substrate has a sufficient concentration of heated resin at the surface thereof for bonding the heated substrate to the shaped surface component; and
thermoforming the heated substrate at a pressure less than or equal to about 500 psi (3447 kPa) to provide a bond at an interface between the surface of the thermoformed substrate and the surface of the shaped surface component.

2. The process of claim 1, wherein a tie layer is disposed at the interface.

3. The process of claim 1, wherein the shaped surface component comprises a film layer, and further wherein the interface is between the surface of the thermoformed substrate and a surface of the film layer.

4. The process of claim 3, wherein a tie layer is disposed at the interface.

5. The process of claim 1, wherein the shaped surface component comprises a film layer and a first compatible layer, and further wherein the interface is between the surface of the thermoformed substrate and a surface of the first compatible layer opposite the film layer.

6. The process of claim 5, wherein a tie layer is disposed at the interface.

7. The process of claim 1, comprising forming the shaped surface component by thermoforming in a mold.

8. The process of claim 7, wherein the thermoformed surface component is cooled in the mold, then contacted with the heated substrate without removal from the mold.

9. The process of claim 7, further comprising removing the thermoformed surface component from the mold, and placing the thermoformed surface component in or on a second mold prior to contacting with the heated substrate.

10. The process of claim 1, wherein a surface of the shaped surface component opposite the heated substrate is adjacent a mold form for maintaining the shaped surface component at a temperature below the thermoforming temperature.

11. The process of claim 1, wherein thermoforming is at a pressure about 1 (6.9 kPa) to about 500 psi (3447 kPa)

12. The process of claim 1, wherein thermoforming is at a pressure of about 10 (69 kPa) to about 100 psi (690 kPa).

13. The process of claim 1, wherein a surface of the heated substrate opposite the shaped surface component is in contact with a conformable pressure-transmitting medium, and further comprising thermoforming the heated substrate by transmitting a thermoforming pressure through the medium.

14. The process of claim 1, wherein a surface of the heated substrate opposite the shaped surface component is in contact with a mold form, and further comprising thermoforming the heated substrate by transmitting a thermoforming pressure through the mold form.

15. The process of claim 1, further comprising a balancing layer positioned adjacent the heated substrate on a side opposite the film layer.

16. The process of claim 1, wherein the surface component or substrate comprises a polycarbonate, acrylonitrile-styrene-acrylic, acrylic, acrylonitrile-butadiene-styrene, polybutylene terephthalate, polyethylene terephthalate, polyolefin, arylate polyester, or a blend, alloy, or copolymer comprising at least one of the foregoing resins.

17. The process of claim 1, wherein the surface component comprises a polymer comprising units of an arylate polyester.

18. The process of claim 1, wherein the surface component comprises a film layer comprising arylate polyester units and a first compatible layer comprising an additive for providing an aesthetic effect.

19. The process of claim 18, wherein the film layer comprises a block copolyester carbonate comprising arylate polyester-containing block segments in combination with organic carbonate block segments and the first compatible layer comprises a colorant.

20. A process for forming an article, comprising
thermoforming a reinforced resinous substrate to provide a shaped reinforced resinous substrate;
thermoforming a surface component, wherein the shape of the surface component substantially matches the shape of the reinforced resinous substrate; and
joining a surface of the shaped reinforced resinous substrate with a surface of the surface component at an interface.

21. The process of claim 20, wherein the joining is by thermoforming or use of an adhesive.

22. An article made by the process of claim 1.

23. An article made by the process of claim 20.

24. A shaped multilayer article comprising:
a shaped surface component; and
a reinforced resinous substrate, shaped and joined to the surface component at an interface by thermoforming.

25. The article of claim 24, wherein the surface component comprises a film layer and a first compatible layer, wherein the interface is between the substrate and a side of the compatible layer opposite the film layer.

26. The article of claim 24, wherein the surface component or substrate comprises a polycarbonate, acrylonitrile-styrene-acrylic, acrylic, acrylonitrile-styrene-styrene, polybutylene terephthalate, polyethylene terephthalate, polyolefin, arylate polyester, or a blend, alloy, or copolymer comprising at least one of the foregoing resins.

27. The article of claim 24, wherein a surface of the film layer opposite the first compatible layer comprises a weatherable resorcinol polyester resin having a “Class A” finish
